(19) United States
(12) Patent Application Publication
(10) Pub. No.: US 2003/0133536 A1
(43) Pub. Date: Jul. 17, 2003

(54) X-ray fluorescence spectrometer

(75) Inventors: Shoji Kuwabara, Ibaraki-shi (JP); Takao Marui, Hadano-shi (JP)

Correspondence Address: KANESAKA AND TAKEUCHI, 1423 Powhatan Street, Alexandria, VA, 22314, US

(73) Assignee: SHIMADZU CORPORATION

(21) Appl. No.: 10/317,185

(22) Filed: Dec. 12, 2002

(30) Foreign Application Priority Data
Jan. 16, 2002 (JP) 2002-007329

(51) Int. Cl. G01N 23/223

(52) U.S. Cl. 378/44

(57) ABSTRACT

An X-ray fluorescence spectrometer includes an X-ray tube, a collimator or capillary lens for irradiating a primary X-ray from the X-ray tube on a sample, and a detector for detecting an X-ray fluorescence from the sample. The detector is enclosed in a sealed chamber for preventing the X-ray fluorescence from being attenuated by the air. In addition, both ends of the collimator or capillary lens are sealed by thin films having high X-ray permeability for preventing the primary X-ray from being attenuated by the air.

### BACKGROUND OF THE INVENTION AND RELATED ART STATEMENT

The invention relates to an X-ray fluorescence spectrometer for identifying, quantifying and determining a distribution of elements contained in a sample.

In an X-ray fluorescence spectrometer, a primary X-ray is irradiated on a sample. An X-ray detector detects the X-ray fluorescence generated from the sample, and a composing element and an inner structure of the sample are analyzed based on the detected signals.

In the X-ray fluorescence spectrometer, there is a structure where a sample and an X-ray irradiation portion for irradiating the primary X-ray on the sample are disposed in an atmosphere. Also, there is another structure where the X-ray irradiation portion is in a measuring chamber to thereby isolate the portion from the atmosphere. The inside of the measuring chamber is kept in a vacuum state, or with a gas, such as helium in which the primary X-ray and X-ray fluorescence are absorbed less than those in the atmosphere.

FIGS. 3(a) to 3(c) is schematic views showing structures of conventional X-ray fluorescence devices. FIG. 3(a) shows a structure wherein the sample and the X-ray irradiation portion are disposed in the atmospheric pressure; and FIG. 3(b) shows a structure wherein the sample and the X-ray irradiation portion are held in the vacuum or the gas.

In the structure as shown in FIG. 3(a), an X-ray tube 2, a collimator or capillary lens 3, a detector 4 and an optical observation device 5, such as a CCD camera, are disposed in the atmosphere. The primary X-ray is irradiated on a sample S disposed in the atmosphere, and the X-ray fluorescence discharged from the sample S is measured by the detector 4. Also, the optical observation device 5 produces an optical image of the sample S.

Also, in the structure shown in FIG. 3(b), the collimator or capillary lens 3, the detector 4 and the optical observation device 5, such as the CCD camera, are disposed in a measuring chamber 6. The interior of the measuring chamber is held in a vacuum or a gas, such as helium condition. The primary X-ray is irradiated on the sample S disposed in the measuring chamber 6, and the X-ray fluorescence discharged from the sample S is measured by the detector 4.

When an absorption of the X-ray fluorescence of the sample in the air can be negligible, for example, in the case of a characteristic X-ray of a heavy element, the measurement can be carried out under a state where the X-ray source side, such as the X-ray tube and collimator, the sample and the detector side are arranged in the air, as shown in FIG. 3(a). On the other hand, when the absorption of the X-ray fluorescence of the sample in the air is too large to ignore, for example, in the case of a characteristic X-ray of a light element, such as Na, Mg or Al, the atmosphere absorbs a large amount of the X-ray fluorescence. In such a case, although the X-ray tube and the detector are held in a vacuum state, since the other portions are exposed to the atmosphere, the adsorption of the X-ray by the air becomes too large, so that the detection becomes difficult.

In the structure as shown in FIG. 3(b), the whole path of the X-ray including the X-ray source, sample and detector is held in a vacuum or gas atmosphere to thereby prevent the large absorption of the X-ray by the air.

In a structure wherein the X-ray fluorescence analysis is carried out in a vacuum or helium gas atmosphere, when the sample is exchanged, it takes a long preparation time before the measurement due to evacuation of the air in the measuring chamber or substitution of the air therein with a gas. In addition, even after the measurement, since it is necessary to return the interior of the measuring chamber to the atmosphere, the total analysis time becomes long, resulting in poor working efficiency. Also, in the case of an organism sample or a sample containing water, there has been such a problem that the vacuum evacuation can not be carried out.

In view of the problems as described above, a device using a thin film has been proposed as a modified X-ray analyzer, for example, as disclosed in Japanese Patent Publication (KOKAI) No. 08-15187. A structure shown in FIG. 3(c) is one example of such a device where the thin film is used. A measuring chamber 6 includes an opening portion 7, and a thin film 7a having a low X-ray absorption is provided to the opening portion 7. The thin film is arranged between a space provided with the X-ray source and the detector and a space provided with the sample. The X-ray source and the detector are held in a vacuum or gas atmosphere. Therefore, the influence of absorption by the atmosphere can be reduced, and at the same time, since the sample is disposed in the atmosphere, the sample can be easily exchanged. Also, even if the sample is an organism or contains water, the measurement can be carried out.

In the device using the thin film, even the light element, whose characteristic X-ray is greatly absorbed by the atmosphere, can be analyzed. However, since both the primary X-ray and the X-ray fluorescence pass through the thin film provided to the opening portion of the chamber, the thin film absorbs the primary X-ray having lower energy to thereby attenuate. In addition, the X-ray fluorescence is also attenuated due to the absorption by the thin film, and an intensity of the X-ray fluorescence of the light element, such as Na and Mg, becomes too small to perform reliable analysis. Further, the thin film generates unnecessary X-ray fluorescence and scattered X-ray to thereby influence the analyzed data.

Further, since the thin film needs to support a pressure difference between an atmospheric pressure and a vacuum, a diameter of the opening portion to which the thin film is provided must be small. Therefore, there has been a problem such that when the optical observation is carried out by eyes or an optical microscope through the opening, the observation area becomes very small.

Therefore, in the structure wherein the primary X-ray is irradiated and the X-ray fluorescence from the sample in the atmosphere is detected, there has been such a problem that the primary X-ray and the X-ray fluorescence are greatly adsorbed by the atmosphere. In the structure wherein the whole structure including the sample is arranged in a vacuum condition, there has been such a problem that the working efficiency is deteriorated and the structure can not be applied to a sample containing water. In the structure wherein only the measuring portion is positioned in a vacuum condition by providing a window between the measuring portion and the sample, there has been a risk of detecting the X-ray fluorescence and scattered X-ray of the primary X-ray of a small quantity of impurities contained in a material (high polymer thin film) used for the window. Also, since the space and volume to be held in a vacuum condition are relatively large, it is difficult to seal them tight. Therefore, an evacuation device, such as a vacuum pump, is required.

Therefore, in order to solve the above problems, the present invention has been made and an object of the invention is to provide an X-ray fluorescence spectrometer, wherein the attenuation of the X-ray with low energy caused by the atmosphere is prevented. Especially, the characteristic X-ray of the light element can be detected at a high sensitivity. Also, the attenuation of the primary X-ray with low energy and/or the X-ray fluorescence with low energy caused by the atmosphere is prevented.

Further objects and advantages of the invention will be apparent from the following description of the invention.

### SUMMARY OF THE INVENTION

An X-ray fluorescence spectrometer according to the invention includes an X-ray tube; a collimator for controlling a radiation radius of a primary X-ray from the X-ray tube or a capillary lens for condensing the primary X-ray on a sample surface; a detector for detecting an X-ray fluorescence from the sample; a first structure for preventing the X-ray fluorescence from being attenuated by the air; and a second structure for preventing the primary X-ray from being attenuated by the air.

The detector is provided with the first structure for preventing the X-ray fluorescence from being attenuated by the air while the X-ray fluorescence travels from the sample to a detecting element.

The detector includes a detecting window for introducing the X-ray fluorescence therethrough, and a chamber for holding a space between the detecting window and the detecting element in a vacuum condition. The chamber is structured such that the detecting window is positioned closer to the sample to an extent that it does not interfere with the primary X-ray.

With the first structure, the X-ray fluorescence is introduced into the chamber through the detecting window immediately after discharged from the sample. Since the space between the detecting window and the detecting element is in a vacuum state, the X-ray fluorescence is detected by the detecting element without attenuation by the air.

Also, since there is no additional thin film provided at an opening portion like the conventional device, unnecessary X-ray fluorescence and scattered X-ray due to the thin film are not generated.

The collimator or capillary lens is provided with the second structure for preventing the primary X-ray from being attenuated by the air while the primary X-ray from the X-ray source reaches the sample.

The collimator or capillary lens is provided with thin films at the X-ray source side and the sample side. The thin films sealing the two sides are capable of permeating the X-ray and sealing a vacuum, so that the interior of the collimator or capillary lens is held in a vacuum or helium atmosphere.

With this structure, the primary X-ray from the X-ray source is irradiated on a small area of the sample by the collimator or the capillary lens. Since the interior of the collimator or the capillary lens is in a vacuum state, even if the primary X-ray having low energy is used, the primary X-ray is irradiated to the sample without attenuation caused by the air to thereby improve excitation efficiency of the X-ray fluorescence of a light element.

Since only both ends of the collimator or the capillary lens on the X-ray irradiation side are sealed, the vacuum sealing can be maintained for a long period of time. Also, a vacuum pump for evacuation is not required.

### BRIEF DESCRIPTION OF THE DRAWINGS

FIG. 1 is a schematic view showing a structure of an X-ray fluorescence spectrometer of an embodiment according to the invention;

FIG. 2 is a schematic view showing a structure of an X-ray fluorescence spectrometer of another embodiment according to the present invention; and

FIGS. 3(a), 3(b) and 3(c) are schematic views showing conventional X-ray fluorescence spectrometers.

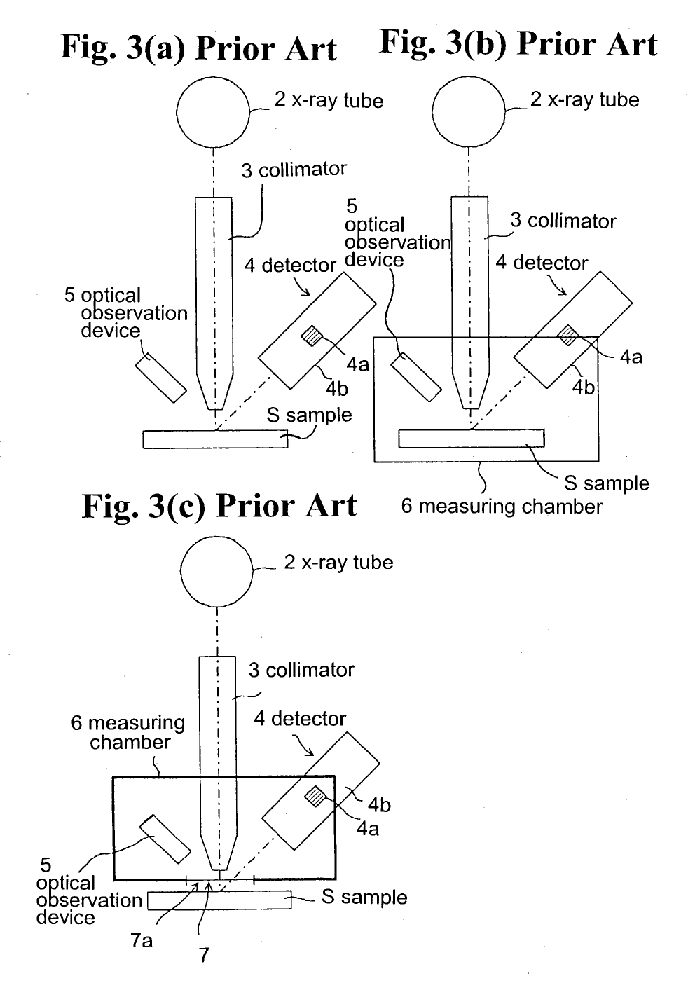

### DETAILED DESCRIPTION OF PREFERRED EMBODIMENTS

Hereunder, embodiments according to the invention will be explained with reference to the accompanying drawings.

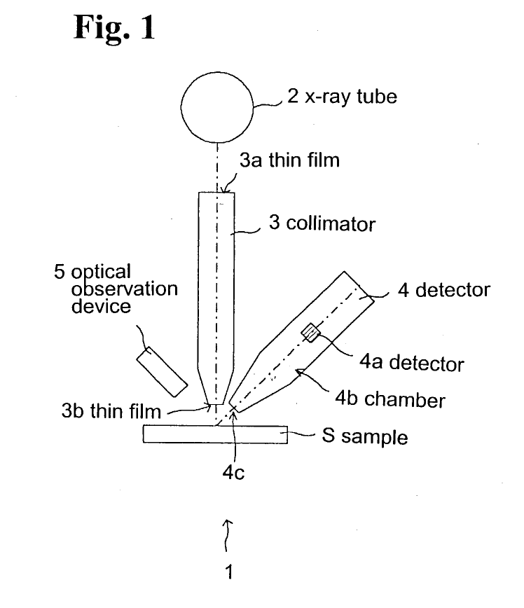

FIG. 1 is a schematic view showing an X-ray fluorescence spectrometer of the present invention. An X-ray fluorescence spectrometer 1 includes an X-ray tube 2 for discharging a primary X-ray; a collimator for controlling a radiation radius of the primary X-ray or a capillary lens for condensing the primary X-ray on a surface of a sample S, (hereinafter referred to as “collimator portion 3”); a detector 4 for detecting an X-ray fluorescence from the sample S; and an optical observation device 5 such as a CCD camera for observing an optical image of the sample S.

The X-ray tube 2 generates a primary X-ray with energy corresponding to a characteristic X-ray of an element to be analyzed, and irradiates the primary X-ray on the sample S through the collimator portion 3.

Both ends, i.e. a side of the X-ray tube 2 and a side of the sample S, of the collimator portion 3 are shielded by thin films 3a, 3b having an X-ray permeability and a vacuum sealing ability. The interior of the collimator portion 3 shielded by the thin films 3a, 3b is held in a vacuum or helium atmosphere. A vacuum pump evacuates the interior of the collimator portion 3 to hold the vacuum state. Alternatively, the interior of the collimator portion 3 may be sealed in the vacuum state. The thin films 3a, 3b are preferably made of a material with a low primary X-ray absorption. It is also preferable that a composition of the thin film itself does not generate the X-ray fluorescence. Additionally, the thin films 3a, 3b have a strength endurable for a pressure about atmospheric pressure. As the material of the thin film as described above, for example, a polyester resin film with a thickness in the order of several micrometers can be used.

Incidentally, in FIG. 1, a device for evacuating the interior of the collimator 3 is omitted.

In a case that Rhodium is used as a target of the X-ray tube, the primary X-ray also includes an L line of Rhodium having a relatively low energy in addition to a K line and a continuous X-ray of Rhodium having high energy. Due to the relatively low energy, when irradiated to the sample through the atmosphere, the L line is easily attenuated by the air, so that a sufficient intensity of the X-ray fluorescence can not be obtained. However, the X-ray fluorescence spectrometer according to the present invention is structured such that both ends of the collimator portion are X-ray permeable and sealed in the vacuum. Therefore, even in the case that a primary X-ray has low energy, the primary X-ray is irradiated to the sample without being attenuated by the air, thereby achieving high excitation efficiency of the X-ray fluorescence of the light element. Thus, a sufficient intensity of the X-ray fluorescence can be obtained.

Incidentally, in the collimator portion 3, the thin film 3b is arranged to be closer to the sample S to an extent where the collimator portion 3 does not interfere with the X-ray fluorescence detected by the detector 4, thereby minimizing a distance between the thin film 3b and the sample S. Thus, the attenuation of the primary X-ray discharged from the X-ray tube 2 by the air can be further suppressed.

The primary X-ray irradiated from the collimator portion 3 on a very small area of the sample S excites an element to be analyzed contained in the sample S to thereby discharge a characteristic X-ray having energy inherent to the element. Generally, it is possible to improve the generation efficiency of the X-ray fluorescence by irradiating the primary X-ray with energy slightly higher than the energy of the characteristic X-ray.

The detector 4 detects the X-ray fluorescence discharged from the sample S. The detector 4 includes a detecting element 4a for detecting the X-ray fluorescence; a chamber 4b for holding the detecting element 4a in a vacuum atmosphere; and a detecting window 4c for introducing the X-ray fluorescence into the chamber 4b. A tip portion of the chamber 4b extends toward the sample S to an extent where it does not interfere with the primary X-ray, so that the detecting window 4c is disposed at a position very close to the sample S. By disposing the detecting window 4c at a position very close to the sample S, the X-ray fluorescence discharged from the sample S passes through a very short distance in the air. Then, the X-ray fluorescence is introduced into the chamber 4b through the detecting window 4c. Since the chamber 4b is held in a vacuum state, the primary X-ray is not attenuated by the air in the space between the detecting window 4c and the detecting element 4a. According to the X-ray fluorescence spectrometer of the invention, since the detecting window 4c is disposed to a position very close to the sample S, the attenuation of the X-ray fluorescence by the air can be negligible.

Also, in the collimator portion 3, the end portion provided with the thin film 3b and the end portion provided with the detecting window 4c of the chamber 4b have a small diameter, so that both end portions can be brought closer to the sample S. Thus, the distances that the primary X-ray and the X-ray fluorescence travel in the atmosphere can be shortened to thereby reduce the attenuation by the air.

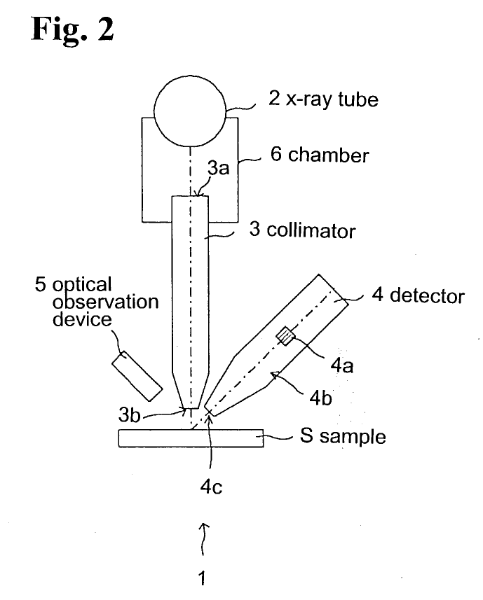

FIG. 2 is a schematic view showing another embodiment of an X-ray fluorescence spectrometer according to the present invention. FIG. 2 shows a structure wherein a section between the X-ray tube 2 and the collimator portion 3 is held in a vacuum or helium atmosphere. Other structural features of the embodiment are the same as those shown in FIG. 1. Therefore, only the different points from those shown in FIG. 1 are explained and the explanations of the other common structures are omitted.

In FIG. 2, at least a space between an X-ray irradiation port of the X-ray tube 2 and an end portion of the collimator portion 3 on a side of the X-ray tube 2 is enclosed in an airtight chamber 6 to be in an airtight space. The interior of the airtight chamber 6 is a vacuum or helium atmosphere. According to the structure, the attenuation of the primary X-ray caused by the air can be further reduced in the section between the X-ray tube 2 and the collimator 3.

In the structure of the present embodiment, the thin films are provided to the detecting window and the collimator portion. The thin films indeed cause attenuation of the primary X-ray and X-ray fluorescence. However, when compared to a conventional structure where a detection device is enclosed in a measuring chamber having an opening portion provided with the thin film, the influence caused by the thin film can be reduced. This is because, in the conventional structure, the X-ray fluorescence passes through twice the thin films provided at the opening portion of the measuring chamber and the detecting window of the detecting device. On the other hand, in the present invention, the X-ray fluorescence passes through the thin film only once at the detecting window of the detecting device. With respect to the primary X-ray, sufficient energy can be maintained by suppressing the attenuation by the air while passing through the thin film portion, and the influence caused by the thin film can be minimized.

Further, since the areas of the thin films at the detecting window and the collimator portion can be reduced to minimum, it is possible to use a thinner film to thereby further reducing the attenuation of the X-ray.

Therefore, according to the structures of the present invention, since not only the heavy element but also the light element in the sample can be effectively excited, the X-ray fluorescence with low excited energy can be effectively detected. Thus, an intensity of the X-ray fluorescence of the light element, such as Na, Mg or Al, which is absorbed largely by the atmosphere, can be detected with high sensitivity.

Also, according to the structures of the invention, when the sample is optically observed, since a field of vision is not limited by the opening portion of the measuring chamber for holding the measuring side in a vacuum state, a wide observation area for the optical observation device 5 can be obtained.

As described above, according to the X-ray fluorescence spectrometers of the invention, the X-ray with low energy, especially the characteristic X-ray of the light element, can be detected with high sensitivity.

While the invention has been explained with reference to the specific embodiments of the invention, the explanation is illustrative and the invention is limited only by the appended claims.

What is claimed is:

1. An X-ray fluorescence spectrometer for analyzing a sample, comprising:
an X-ray tube for generating a primary X-ray,
one of a collimator and a capillary lens disposed near the X-ray tube for irradiating the primary X-ray from the X-ray tube on the sample,
a detector for detecting an X-ray fluorescence generated from the sample, and
at least one of a first structure for preventing attenuation of the X-ray fluorescence by air, said first structure having a detecting window for introducing the X-ray fluorescence into the detector and a first chamber situated between the detecting window and the detector so that the first chamber is in a vacuum state, and a second structure for preventing attenuation of the primary X-ray by air, said second structure having two ends provided with thin films at one of the collimator and the capillary lens so that an interior of said one of the collimator and the capillary lens is held in a vacuum or helium atmosphere.

2. An X-ray fluorescence spectrometer according to claim 1, wherein said detecting window is disposed close to the sample to an extent that the chamber does not interfere with the primary X-ray.

3. An X-ray fluorescence spectrometer according to claim 1, wherein said detecting window is provided with a thin film.

4. An X-ray fluorescence spectrometer according to claim 2, further comprising a second chamber for enclosing at least a part of the X-ray tube and a part of said one of the collimator and the capillary lens so that the primary X-ray travels from the X-ray tube to the one of the collimator and the capillary lens through the second chamber, an inside of said second chamber being held in a vacuum or helium atmosphere.

5. An X-ray fluorescence spectrometer according to claim 2, wherein said thin films in the first and second structures are formed of a material having high X-ray permeability.
